(19) United States
(12) Patent Application Publication
(10) Pub. No.: US 2014/0110403 A1
(43) Pub. Date: Apr. 24, 2014

(54) HERMETICALLY CLOSED PACKAGE TO BE HEATED IN A MICROWAVE OVEN

(71) Applicants: Henrik Nedell, Them (DK); Paul Schlemmer, Ega (DK); Willy Meldgaard-Andersen, Horsens (DK)

(72) Inventors: Henrik Nedell, Them (DK); Paul Schlemmer, Ega (DK); Willy Meldgaard-Andersen, Horsens (DK)

(73) Assignee: AMCOR FLEXIBLES TRANSPAC B.V.B.A., Zaventem (BE)

(21) Appl. No.: 14/118,335

(22) PCT Filed: May 25, 2012
(86) PCT No.: PCT/EP2012/059791

§ 371 Date: Nov. 18, 2013

(30) Foreign Application Priority Data
May 26, 2011 (EP) 11167604.5

(51) Int. Cl. H05B 6/80

(52) U.S. Cl. CPC H05B 6/80
USPC 219/730

(57) ABSTRACT

A hermetically closed package enclosing a product comprises a wall formed of a packaging material including a first polymer film (7) and a second polymer film (10) being co-extensive with the packaging material, the first polymer film (7) is laminated to the second polymer film (10) by means of an adhesive layer (16). One of the polymer films is provided in a limited region thereof with a layer of a material generating heat when subjected to microwave radiation, i.e. a heat-generating layer (5) having susceptor effect. The heat-generating effect, i.e. the susceptor effect, of the heat-generating layer (5) is selected so as to melt, decompose, soften or weaken the first polymer film (7) and/or the second polymer film (10) in the limited region as seen transversely of the packaging material to such a degree that an opening is formed in the limited region.

The present invention relates to a hermetically closed package enclosing a product, especially a food product, to be heated in a microwave oven while being enclosed in said package, said package comprising a wall formed of a packaging material including a first polymer film and a second polymer film being co-extensive with the packaging material, the first polymer film having a first surface and second surface, the second polymer film having a first surface and a second surface, the first surface of the second polymer film being laminated to the second surface of the first polymer film by means of an adhesive layer.

A known package for a food product comprises a wall formed of a packaging material provided with perforations which are covered by holt-melt layer. When the temperature exceeds the melting point of the hot-melt during heating in a microwave oven, the hot-melt melts and steam generated by the product when heated escapes through the perforations. However, such a package is not particularly suitable for pasteurisation or heat sterilisation due to the a risk of the hot-melt melting or decomposing during such processes as the temperature during these processes is not essentially lower than during heating in a microwave oven.

In this respect it should be noted that in general pasteurisation is carried out at a temperature of 72° C. for fifteen seconds, at 87° C. for fifteen seconds or at 90° for five seconds. Further, in general heat sterilisation is carried out at a temperature of 121° C. for fifteen minutes or 134° C. for three minutes.

JP-A-63307085 discloses a food package for microwave oven cooking comprising a container provided with a lid. The lid is provided with a steam escape hole covered by a valve sheet in the form of a label. The valve sheet comprises a layer of substance generating heat when subjected to microwaves, i.e. a so-called susceptor layer adhered to a base film. The valve sheet is adhered to the lid so as to close the steam escape hole by means of an adhesive. When the package is heated in a microwave oven, the adhesive is softened to lower its bonding strength. When a certain steam pressure is generated in the package, the valve sheet is exfoliated from the lid to allow steam to escape through the steam escape hole in the lid.

EP-A-0 156 404 discloses a package with a packed product which has been subjected to heat treatment while being packed in the package. A wall of the package is provided with a pressure-balancing opening being hermetically sealed by means of heat-meltable polymer, i.e. a hot-melt. In a first embodiment the hot-melt is applied at the opening after the heat treatment. In a second embodiment the hot-melt has a melting point lower than the heat treatment temperature and is applied across the opening before the heat treatment and is caused to melt and then so solidify again so as to seal the opening.

U.S. Pat. No. 4,210,674 discloses a tray which is hermetically sealed by a film of polyester, such as polyethylene terephthalate, to which a narrow strip of aluminium foil is adhesively secured. When the aluminium foil has certain dimensions, it converts microwave energy to heat sufficient to melt the plastic film, thus venting the package. Dispersions of metal powder, such as copper or silver powders, may be used as substituent for the aluminium foil and may be applied by printing or spraying.

EP-A-1 067 058 discloses a stand-up pouch for use in a microwave oven. The pouch has a front wall and a rear wall made of coextruded polymer films with e.g. an outer film of polyester or polyamide and an inner film of polyethylene or polypropylene. A means for automatically venting is arranged in the empty upper part of the pouch. The means for venting includes sealing the opposite pouch walls together so as to form a star-shaped sealing area. An ink containing metal powder, such as aluminium or bronze powder, is applied to one of the inner films before sealing so as to form a metallic charge in the vicinity of the pointed star-shaped sealing area. Upon heating the pouch in a microwave oven, the metallic charge results in a local temperature increase and facilitates rupture of the inner film along the circumference of the star-shaped sealing area. A perforation in the outer film enables venting upon rupture of the inner film.

U.S. Pat. No. 4,640,838 discloses a self-venting microwave oven package having a duplex film with an outer layer of a bi-axially oriented polyethylene terephthalate film and an inner layer of polypropylene. One embodiment includes a thermoplastic film to which a piece of a layer filled with microwave-absorbing particles is adhered by an adhesive layer which softens and melts at a temperature lower than does the binder of the piece of microwave-absorbing particle-filled layer. A slit is arranged in the thermoplastic film underneath the piece of microwave-absorbing particle-filled layer. The package is vented when vapour pressure and temperature reach a level sufficient to soften and open a channel laterally through the adhesive layer.

EP 0218419 discloses a microwave food package comprising a top sheet and a bottom sheet sealed to each other along a sealing seam. A piece of metal coated film is adhered to the top sheet. When subjected to microwaves, the piece of metal coated film is heated, whereby the piece and the top sheet are softened. Due to the pressure in the interior of the package, the top sheet and the piece of metal coated film are ruptured, whereby the package is vented. The piece may also be arranged at the sealing seam as shown in FIG. 9, where the piece has the reference number 60 and the seam has the reference number 59.

EP 0188105 discloses a method for perforating a polymer film by applying spots of conductive material to a surface of the film and subjecting the film to microwaves so as to heat the spots sufficiently to perforate the film. The spots may be printed to the film and contain carbon black in an amount of 65%.

The object of the present invention is to provide a package of the above type which preferably allows for heat treatment, especially pasteurisation, of the product being hermetically enclosed in the package, an opening being formed in said package when the product enclosed therein later is heated or cooked in a microwave oven.

The package according to the invention is characterised in that the first surface or the second surface of the first polymer film or the first surface or the second surface of the second polymer film is provided in a limited region thereof with a layer of a material generating heat when subjected to microwave radiation, i.e. a heat-generating layer having susceptor effect, said heat-generating layer being deposited or printed on the first or second surface of the first polymer film or on the first or second surface of the second polymer film and having an extent substantially smaller than the extent of the wall and having an electrical conductivity corresponding to a surface resistance of 4 to 9000 ohms per square measured according to DIN IEC 93, and that preferably, the packaging material is provided with a non-through-going or a through-going perforation in the first polymer film in the region of the heat-generating layer as seen transversely of the packaging material. The susceptor effect of the heat-generating layer is selected such that when subjected to a prescribed amount of microwave radiation, the first polymer film and/or the second polymer film melt, decompose, soften or weaken to such a degree that the packaging material disintegrates to form a through-going opening therethrough in line with the perforation in the first polymer film.

The electrical conductivity of the heat generating layer is adapted to get a controlled heat absorption over a time period. The heat absorption in the packaging material in the region of the heat-generating layer must not be too intensive so as to avoid burning through of the material. On the other hand, the heat absorption must be high enough to allow local melting of the packaging material.

Within optimum limits of the surface resistance no pressure from inside of a package is needed for forming the opening. The perforation of the first polymer film provides a weakening thereof and thereby allowing for obtaining a venting hole of the desired size without any burning of the packaging material when the packaging material is subjected to microwaves. The size of the venting hole depends on the size of the perforation. A small venting hole is an advantage in order to obtain as high a pressure as possible inside the package without bursting the package. By maintaining a high pressure during cooking, the taste and smell of the food product is better maintained.

The phrase polymer film is meant encompass both a film comprising a single polymer layer, a film comprising two or more polymer layers such as co-extruded layers and a film comprising two or more laminated polymer layers.

The word perforation is to be understood as a slit and/or an opening having any suitable shape and/or size.

The first polymer film may be an oriented film.

The adhesive layer can be formed of any suitable adhesive used for lamination, such as a polyurethane-based adhesive.

The heat-generating layer may have an electrical conductivity corresponding to a surface resistance of 100 to 9000 ohms per square. Alternatively, 500-6000 ohms per square, alternatively 500-3000 ohms per square, alternatively 500-2000 ohms per square and alternatively 700-1500 ohms per square. Preferably, the heat-generating layer has an electrical conductivity corresponding to such a surface resistance that at least 24 W is absorbed by the heat-generating layer when the package is heated in a microwave oven.

When the product enclosed in the package is to be subjected to a heat treatment while being hermetically enclosed in the package, the polymeric materials of the package including the packaging material comprising the first and second polymer film are selected so as to not melt, decompose, soften or weaken so such a degree that internal steam generated during the heat treatment of the package causes an opening in the package to be formed. In other words, the polymer materials of package do not loose integrity, i.e. they are able to withstand temperatures between 72° C. and 90° C. when subjected to pasteurisation and temperatures between 121° C. and 134° C. when subjected to heat sterilisation depending on the heat treatment selected.

During the chosen heat treatment the heat-generating material does not reach a temperature exceeding the temperature used for the heat treatment. However, during the subsequent heating or cooking of the product enclosed in the package in a microwave oven the heat-generating material obtains a higher temperature than during the previous heat treatment due to the susceptor effect thereof so as to melt, decompose, soften or weaken the specific polymer material in the limited region to cause an opening to be formed in the wall formed of the packaging material.

In its entirety, the package can be formed of the packaging material. Alternatively, the wall formed of the packaging material is a lid of a container, such as a tray.

The first surface of the first polymer film can be directed to the exterior of the package and the second surface of the first polymer film to the interior of the package. Thereby, the first polymer film, which is provided with the perforation, is arranged exterior of the second polymer film as seen relative to the food product enclosed in the package. It should however be noted that it is also possible to arrange the first polymer, which is provided with the perforation interior of the second polymer film as seen relative to the food product enclosed in the package.

The first surface of the first polymer film of the packaging material may be an outer surface of the package and the second surface of the second polymer film of the packaging material may be an inner surface of the package.

It should however be noted that the first surface of the first polymer film may be the inner surface of the package and the second surface of the second polymer film of the outer surface of the package.

As non-limiting examples, the packaging material can comprise a first polymer film of polyethylene terephthalate (PETP), a PET film with a deposited aluminium oxide layer (PETP-alox) or a layer of silicon oxide (PETP-SiOx), a polyamide film (PA), an oriented PA film (OPA), an oriented polypropylene film (OPP). Additionally the packaging material can comprise a paper layer, a cellophane film and/or a layer of ethylene vinyl alcohol (EVOH). Further, it should be noted that at its inner face, i.e. the surface facing the product to be packed, the packaging material comprises a sealable layer, preferably a heat-sealable layer comprising polyethylene (PE), polypropylene (PP) or sealable PETP. The surface facing the product to be packed can be the second surface of the second polymer film which is preferably a heat-sealable layer.

In case the package in its entirety is to be formed of the packaging material, the inner face thereof is a sealable layer which can be sealed to itself, i.e. inner to inner face.

When the packaging material is to be used as a lid of a container, the inner face of the packaging material is formed of a sealable layer which can be sealed to the material of which the container is formed.

As non-limiting examples the material for forming a container can comprise a film of PETP, PP or PE.

Finally, the material for forming the container comprises a sealable layer to which the sealable layer of the packaging material can be sealed, preferably heat-sealed.

The limited region of the heat-generating layer may be of any suitable size. Example of the size of the layer is an area ranging between about 3 mm2 and about 600 mm2, alternatively between 6 mm2 and 300 mm2 and alternatively between 9 mm2 and 150 mm2.

According to the invention the heat-generating layer may be arranged and shaped so as to overlap or not overlap any perforations in the packaging material as seen transversely thereof. In this connection the heat-generating layer may extend around any perforation in the packaging material as seen transversely thereof and spaced apart therefrom.

The heat-generating layer may be arranged totally outside of sealing seams of the packaging material as seen transversely of the packaging material. On the other hand, the heat-generating layer may overlap at least in part a sealing seam of the packaging material as seen transversely of the packaging material to provide an easy opening device.

The perforation may include at least one slit having a length of at least 1 mm such as 3 to 25 mm, preferably 3 to 12 mm.

The perforation may include two or more crossed slits.

The heat-generating layer may be a metallised layer, especially provided by physical vapour deposition (PVS) and especially an aluminium layer.

Further, according to the invention the heat-generating layer may be a printing ink containing particles having susceptor effect such as graphite or carbon, indium oxide, tin oxide or a metal such as aluminium, silver, nickel, tin or stainless steel, preferably graphite or carbon particles or aluminium particles.

The package according to the invention may be used for heating the product enclosed therein in a microwave oven.

Additionally, the package according to the invention may be used for heat treatment, especially pasteurisation, of the product being hermetically enclosed therein and subsequent heating of the product being enclosed therein in a microwave oven.

Finally, the present invention relates to a package according to the invention which has been subjected to a heat treatment with the package product being hermetically enclosed therein and which package subsequently is to be heated in a microwave oven.

Further advantages, features and details of the invention are revealed in the following description of material and methods as well as preferred exemplified embodiments and with the aid of the drawing which shows schematically in

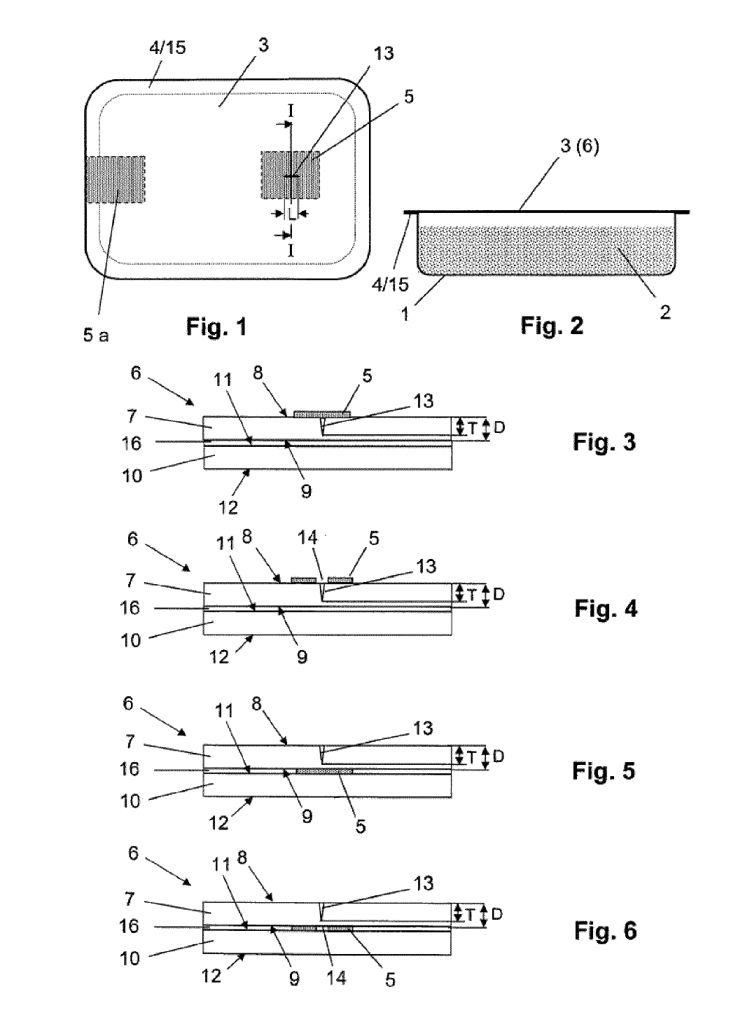

FIG. 1 is a top view of an embodiment of the package according to the invention comprising a container being hermetically closed by a lid formed of a packaging material;

FIG. 2 is a side view of the embodiment shown in FIG. 1;

FIG. 3 is an enlarged sectional view along the line I-I in FIG. 1 of a first version of a first embodiment of the packaging material;

FIG. 4 is an enlarged sectional view along the line I-I in FIG. 1 of a second version of a first embodiment of the packaging material;

FIG. 5 is an enlarged sectional view along the line I-I in FIG. 1 of a first version of a second embodiment of the packaging material;

FIG. 6 is an enlarged sectional view along the line I-I in FIG. 1 of a second version of a second embodiment of the packaging material.

The embodiment of the package according to the invention disclosed in FIGS. 1 and 2 comprises a container 1 in the form of a tray containing a food product 2 and being hermetically closed by a lid 3 sealed to a rim 4 of the container. The lid forms a wall of the package and is made from a packaging material 6 provided in a limited region of the wall with a layer 5 of a material generating heat when subjected to microwave radiation, i.e. a material having a susceptor effect. The heat-generating layer 5 may be arranged totally outside of sealing seams 15 of the packaging material as seen transversely of the packaging material. On the other hand, a heat-generating layer 5 a may overlap at least in part a sealing seam 15 of the packaging material as seen transversely of the packaging material so as to provide an easy opening device.

In the first version of the first embodiment of the packaging material 6 shown in FIG. 3 the packaging material 6 comprises a first polymer film 7 having a first surface 8 and a second surface 9. The packaging material 6 further comprises a second polymer film 10 having a first surface 11 and a second surface 12. The first surface 11 of the second polymer film 10 is laminated to the second surface 9 of the first polymer film 7 by means of an adhesive layer 16. The first surface 8 of the first polymer film 7 is provided with the layer 5 in a limited region, said layer 5 generating heat when subjected to microwave radiation. The layer 5 is a metallisation layer deposited directly on the first surface 8 of the first polymer film 7 or a printing ink comprising particles having susceptor effect and printed directly on the first surface 8 of the first polymer film 7. The first polymer film 7 has a thickness D of e.g. 12 μm. A perforation 13 in the form of a slit starting from the first surface 8 has a depth T of e.g. 0.5−1.0×D and a length L of e.g. 7 mm. The heat-generating layer 5 covers the perforation 13 as seen transversely of the packaging material.

In this first version of the first embodiment of the packaging material the susceptor effect of the heat-generating layer 5 is selected so that when the package is placed in a microwave oven and subjected to a prescribed amount of microwave radiation for heating or cooking the packed product, the susceptor effect of the heat-generating layer 5 melts or softens the packaging material to such a degree that the release of tension in the packaging material 6 generated by the heating of the packed product causes an opening to be formed in the layer 5 starting from the tip of perforation 13.

FIG. 4 discloses a modification essentially corresponding to the one shown in FIG. 3 except that the heat-generating layer 5 is shaped as a ring having an opening 14. The opening 14 is arranged in line with the perforation 13 and the ring-shaped heat generating layer 5 surrounds the perforation 13 spaced apart therefrom as seen in the transverse direction of the packaging material. The susceptor effect of the heat generating layer 5 is selected so as to melt the first polymer film 7 and the second polymer film 10 in line with the perforation 13 and thereby providing an opening to the packaging material. Due to the ring shape of the heat-generating layer 5 the printing ink or the metallisation does not come into direct contact with food product after an opening has been melted through the packaging material. The first surface 8 of the first polymer film 7 is preferably the outer surface of the package, i.e. the surface facing away from the packed product.

The first version of the second embodiment of the packaging material 6 shown in FIG. 5 comprises a first polymer film 7 having a first surface 8 and a second surface 9 and a second polymer film 10 having a first surface 11 and a second surface 12. The first surface 11 of the second polymer film 10 is laminated to the second surface 9 of the first polymer film 7 by means of an adhesive layer 16. The heat-generating layer 5 is deposited or printed directly on the second surface 9 of the first polymer film 7, whereby the layer 5 becomes an intermediate layer between the first polymer film 7 and the second polymer film 10. The susceptor effect of the heat-generating layer 5 is selected so that said layer melts an opening in both the first polymer film 7 and the second polymer film 10 when subjected to a prescribed amount of microwave radiation needed to heat or cook the packed food product. The second surface 9 of the first polymer film 7 is provided with the layer 5 in a limited region, said layer 5 generating heat when subjected to microwave radiation. The layer 5 is a metallisation layer deposited directly on the second surface 9 of the first polymer film 7 or a printing ink comprising particles having susceptor effect and printed directly on the second surface 9 of the first polymer film 7. The first polymer film 7 has a thickness D of e.g. 12 μm. A perforation 13 in the form of a slit starting from the first surface 8 has a depth T of e.g. 0.5−1.0×D and a length L of e.g. 7 mm. The heat-generating layer 5 covers the perforation 13 as seen transversely of the packaging material.

The modification shown in FIG. 6 essentially corresponds to the version shown in FIG. 5 except that the heat-generating layer 5 is ring-shaped with an opening 14 in line with the perforation 13 in the first polymer film 7. During heating in a microwave oven, the heat generated by the heat-generating layer 5 melts an opening in the second polymer film 10, whereby a through-going opening is provided in the packaging material. As the rings-shaped heat-generating layer 5 surrounds the opening 13 spaced apart therefrom as seen in the transverse direction of the packaging material, the printing ink or metallisation of the heat-generating layer 5 does not come into direct contact with the packed food product—neither before nor after a through-going opening has been formed in the packaging material.

In a first version of a third embodiment the heat-generating layer 5 is deposited or printed directly on the first surface 11 of the second polymer film 10, whereby the heat-generating layer 5 becomes an intermediate layer between the first polymer film 7 and the second polymer film 10. The first version of the third embodiment thereof corresponds to the first version of the second embodiment except that the heat-generating layer 5 is not deposited or printed on the second surface 9 of the first polymer film 7, but to the first surface 11 of the second polymer film 10, said first surface 11 facing the second surface 9 of the first polymer film 7.

In order to avoid iterations it should be noted the first version of the third embodiment functions as described with respect to the first version of the second embodiment.

In a modification of the third embodiment, the heat-generating layer 5 is ring-shaped with an opening as shown in FIG. 6. However, the heat-generating layer 5 is deposited or printed on the first surface 11 of the second polymer film 10 as described above. The modification of the third embodiment thus functions as described with reference to the modification of the second embodiment.

### EXAMPLES

A packaging material corresponding to the one shown in FIG. 5 was produced as follows:

A 12 μm thick PETP film was reverse side printed with a black printing ink containing carbon black. Before printing the black colour on the film, a white PVB (polyvinyl butyral) ink was printed on the same areas of the film. The black colour was printed with 5 different amounts of the colour on the film. After printing, the PETP film was laminated with a 60 μm thick PP film.

Samples were made with a slit in the PETP side of the laminate for each of the 5 different amounts of black colour. The slit was 7 mm long, 0.1 mm wide and the depth of the slit was 6 and 12 μm, respectively. Each of the 10 different samples was sealed against a PP container containing water.

The sealed container was placed in a microwave oven with an effective effect of 644 W (input effect 1400 W) for 30 seconds. It was examined if there was an opening in the laminate after treatment in the microwave oven.

The electrical resistance of the printed areas was measured on the printed PETP film before lamination. Since the electrical resistance is inversely proportional to the conductivity, the electrical resistance of the printed area is an indirect measure for the electrical conductivity of the printed area, i.e., when resistance increases, conductivity decreases.

The measurement setup was performed with respect to IEC 93 description of isolation measurements. The mechanical measurement setup is performed on a quadratic surface, in this case approximately 61.5×61.5 mm, where both sides are connected with a low resistance and good mechanical contact material. The material for this measurement was polyester coated with nickel and copper (Flextron 3027-217 from Laird Technologies).

The electrical resistance of 6 samples each of the 5 types of the printed PETP film with different amounts of carbon black has been measured. The results are shown in Table 1.

TABLE 1
Measured electrical resistance at different amounts of carbon black

| | A | B | C | D | E |
|---|---|---|---|---|---|
| Sample No. | Ω/square] | [Ω/square] | [Ω/square] | [Ω/square] | [Ω/square] |
| 1 | 12511 | 8375 | 7275 | 7114 | 4049 |
| 2 | 12254 | 8312 | 7170 | 7041 | 4102 |
| 3 | 12143 | 8442 | 7295 | 7085 | 4112 |
| 4 | 11961 | 8411 | 7295 | 7042 | 4138 |
| 5 | 12230 | 8350 | 7291 | 7080 | 4287 |
| 6 | 12080 | 8290 | 7322 | 7092 | 4114 |

Table 2 shows the correlation between the electrical resistance of the heat-generating layer and the observation of an opening in the laminate after treatment in the microwave oven for two different slit depth.

TABLE 2
Observed opening at different slit depth

| Slit depth [μm] | A | B | C | D | E |
|---|---|---|---|---|---|
| 6 | − | − | − | − | + |
| 12 | − | − | + | + | + |

+ opening
− no opening

Although the heat-generating layer of the packaging material can be provided as a deposited layer, especially a metallisation layer, as well as a printed layer, the latter is preferred.

In the disclosed embodiments of the package, the perforation is provided in the first polymer film, which is the outer film. It should however be noted that the packaging material may also be reversed so that the first polymer film, which is provided with the perforation, is the inner film facing the enclosed product.

Finally, it should be mentioned that in general it is to be avoided to provide the heat generating layer on a surface of the packaging material being in contact with the enclosed product, especially when the enclosed product is a food product.

### LIST OF REFERENCE NUMBERS

1 container
2 food product
3 lid
4 rim
5 heat-generating layer
6 packaging material
7 first polymer film
8 first surface of the first polymer film
9 second surface of the first polymer film
10 second polymer film
11 first surface of second polymer film
12 second surface of second polymer film
13 perforation in first polymer film
14 opening in heat-generating layer 5
15 sealing seam of packaging material 6 on rim 4
16 adhesive layer
D thickness of first polymer film 7
T depth of perforation 13 in polymer film 7
L length of perforation 13

1. Hermetically closed package enclosing a product (2), especially a food product, to be heated in a microwave oven while being enclosed in said package, said package comprising a wall (3) formed of a packaging material including a first polymer film (7) and a second polymer film (10) being co-extensive with the packaging material, the first polymer film (7) having a first surface (8) and a second surface (9), the second polymer film (10) having a first surface (11) and a second surface (12), the first surface (11) of the second polymer film (10) being laminated to the second surface (9) of the first polymer film (7) by means of an adhesive layer (16), said package further comprising a layer of a material generating heat when subjected to microwave radiation, i.e. a heat-generating layer (5) having susceptor effect,
characterised in that
a limited region of the first surface or the second surface is provided with the heat-generating layer (5), said heat-generating layer (5) being deposited or printed on first or second surface (8, 9) of the first polymer film (7) or to the first or second surface (11, 12) of the second polymer film (10) and having an extent substantially smaller than the extent of the wall (3) and having an electrical conductivity corresponding to a surface resistance of 4 to 9000 ohms per square measured according to DIN IEC 93, and that the packaging material is provided with a non-through-going or through-going perforation in the first polymer film (7) in the region of the heat-generating layer (5) as seen transversely of the packaging material, and wherein the susceptor effect of the heat-generating layer (5) is selected such that when subjected to a prescribed amount of microwave radiation, the first polymer film (7) and/or the second polymer film (10) are capable of melting, decomposing, softening or weakening to such a degree that the packaging material disintegrates to form a through-going opening there through in line with the perforation in the first polymer film (7).

2. Package according claim 1, wherein the heat-generating layer (5) has an electrical conductivity corresponding to a surface resistance of 100 to 9000 ohms per square, alternatively 500 to 9000 ohms per square, alternatively 500 to 6000 ohms per square, alternatively 500 to 3000 ohms per square or alternatively 500-2000 ohms per square, measured according to DIN IEC 93.

3. Package according to claim 1, wherein the first surface (8) of the first polymer film (7) is directed to an exterior of the package and the second surface (9) of the first polymer film (7) is directed to the interior of the package.

4. Package according to claim 1, wherein the first surface (8) of the first polymer film (7) of the packaging material is an outer surface of the package.

5. Package according to claim 1, wherein the second surface (12) of the second polymer film (10) of the packaging material is an inner surface of the package.

6. Package according to claim 1, wherein the first polymer film (7) is an oriented film.

7. Package according to claim 1, wherein the heat-generating layer (5) is arranged in an area outside of sealing seams (15) of the packaging material as seen transversely of the packaging material.

8. Package according to claim 1, wherein the heat-generating layer (5 a) overlaps at least in part a sealing seam (15) of the packaging material as seen transversely of the packaging material to provide an easy opening device.

9. Package according to claim 1, wherein the perforation includes at least one slit having a length of at least 1 mm such as 3-25 mm, preferably 3 to 12 mm.

10. Package according to claim 9, wherein the perforation includes two crossed slits.

11. Package according to claim 1, wherein a non-through-going perforation extends through and has at least 10%, alternatively at least 20, 30, 40 or 50% of the thickness of a first polymer film.

12. Package according to claim 1, wherein the heat-generating layer (5) is arranged and shaped so as to overlap any perforations in the packaging material as seen transversely thereof.

13. Package according to claim 1, wherein the heat-generating layer (5) is arranged and shaped so as to not overlap any perforations in the packaging material as seen transversely thereof.

14. Package according to claim 1, wherein the heat-generating layer (5) is a metallisation layer, especially provided by physical vapour deposition (PVS) and especially an aluminium layer.

15. Package according to claim 1, wherein the heat-generating layer is a printing ink containing particles having susceptor effect such as graphite or carbon, indium oxide, tin oxide or a metal such as aluminium, silver, nickel, tin or stainless steel, preferably graphite or carbon particles or aluminium particles.

16. Package according to claim 1, wherein the heat-generating layer (5) has an electrical conductivity corresponding to such a surface resistance that at least 24 W is absorbed by the heat-generating layer when the package is heated in a microwave oven.

17. Use of a package according to claim 1, wherein the package and the product enclosed therein is subjected to heat treatment, and subsequent heating of the package with the product enclosed therein in a microwave oven.

18. Use according to claim 17, wherein the heat treatment is pasteurisation.

19. Use according to claim 17, wherein the heat treatment is sterilisation.
